(19) United States
(12) Patent Application Publication
(10) Pub. No.: US 2026/0101375 A1
(43) Pub. Date: Apr. 9, 2026

(54) METHODS FOR INTERACTIVE DATA TRANSMISSION AND COMMUNICATION DEVICES UTILIZING THE SAME

(71) Applicant: MEDIATEK INC., Hsinchu City (TW)

(72) Inventors: Chien-Chih Chen, Hsinchu City (TW); Shun-Yong Huang, Hsinchu City (TW)

(73) Assignee: MEDIATEK INC., Hsinchu City (TW)

(21) Appl. No.: 19/330,851

(22) Filed: Sep. 17, 2025

Related U.S. Application Data
(60) Provisional application No. 63/704,074, filed on Oct. 7, 2024.
(60) Provisional application No. 63/760,131, filed on Feb. 19, 2025.

(51) Int. Cl. H04W 74/0816; H04L 5/00

(52) U.S. Cl. CPC H04W 74/0816; H04L 5/0053

(57) ABSTRACT

A method for interactive data transmission includes determining a duration of an interactive data transmission between a first device and a second device, wherein the duration of the interactive data transmission covers a time required for transmitting a first data frame of the first device and a time required for transmitting a second data frame of the second device; setting a duration field of a first frame based on the duration of the interactive data transmission; transmitting the first frame, wherein the first frame is a Request to Send (RTS) frame transmitted by the first device or a Clear to Send (CTS) frame transmitted by the second device; transmitting the first data frame by the first device within the duration of the interactive data transmission; and transmitting the second data frame by the second device within the duration of the interactive data transmission.

### CROSS REFERENCE TO RELATED APPLICATIONS

This application claims the benefit of U.S. Provisional Application No. 63/760,131, filed on Feb. 19, 2025. Further, this application claims the benefit of U.S. Provisional Application No. 63/704,074, filed on Oct. 7, 2024. The contents of these applications are incorporated herein by reference.

### BACKGROUND

Wi-Fi Aware or NAN (Neighbor Awareness Networking) is a protocol that allows Wi-Fi devices to discover services in their proximity. NAN scales effectively in dense Wi-Fi environments and complements the connectivity of Wi-Fi by providing information about people and services in the proximity. Compared with Wi-Fi Direct (P2P), Wi-Fi NAN provides a more reliable connection and a higher throughput.

As Wi-Fi Aware achieves direct connection and data transmission between Wi-Fi devices, Wi-Fi Aware becomes more and more popular in nowadays. Therefore, the performance of communication over Wi-Fi Aware is a topic worth developing.

### SUMMARY

According to an embodiment of the invention, a method for interactive data transmission comprises: determining a duration of an interactive data transmission between a first device and a second device, wherein the duration of the interactive data transmission covers a time required for transmitting a first data frame of the first device and a time required for transmitting a second data frame of the second device; setting a duration field of a first frame based on the duration of the interactive data transmission; transmitting the first frame, wherein the first frame is a Request to Send (RTS) frame transmitted by the first device or a Clear to Send (CTS) frame transmitted by the second device; transmitting the first data frame by the first device within the duration of the interactive data transmission; and transmitting the second data frame by the second device within the duration of the interactive data transmission.

According to another embodiment of the invention, a communication device comprises a transceiver circuit transmitting and receiving a plurality of wireless signals to and from a peer device and a processor receiving, via the transceiver circuit, a Request to Send (RTS) frame from the peer device and obtaining duration information associated with the RTS frame, and in response to reception of the RTS frame, transmitting, via the transceiver circuit, a Clear to Send (CTS) frame. Before transmitting the CTS frame, the processor further determines a duration of an interactive data transmission according to the duration information associated with the RTS frame and sets a duration field of the CTS frame based on the duration of the interactive data transmission. The duration of the interactive data transmission covers a time required for the peer device to transmit a first data frame and a time required for the communication device to transmit a second data frame.

According to another embodiment of the invention, a communication device comprises a transceiver circuit transmitting and receiving a plurality of wireless signals to and from a peer device and a processor transmitting, via the transceiver circuit, a Request to Send (RTS) frame and receiving, via the transceiver circuit, a Clear to Send (CTS) frame from the peer device. Before transmitting the RTS frame, the processor further determines a duration of an interactive data transmission between the communication device and the peer device and sets a duration field of the RTS frame based on the duration of the interactive data transmission. The duration of the interactive data transmission covers a time required for the communication device to transmit a first data frame and a time required for the peer device to transmit a second data frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exemplary block diagram of a communication device according to an embodiment of the invention.

FIG. 2 shows an exemplary flow chart of a method for interactive data transmission according to an embodiment of the invention.

FIG. 3 is a timing diagram showing an interactive data transmission achieved after applying the proposed method according to an embodiment of the invention.

FIG. 4 is a timing diagram showing NAV configurations associated with the RST frame and CTS frame according to a first embodiment of the invention.

FIG. 5 is a timing diagram showing NAV configurations associated with the RST frame and CTS frame according to a second embodiment of the invention.

### DETAILED DESCRIPTION

FIG. 1 is an exemplary block diagram of a communication device according to an embodiment of the invention. The communication device 100 may at least comprise an antenna module comprising at least one antenna, a transceiver circuit 110, a baseband signal processing circuit 120 and a processor 130. The transceiver circuit 110 may be configured to transmit and receive, via the antenna module, wireless signals to and from a peer device (or, to and from an air interface of a wireless network comprising the peer device), so as to communicate with the peer device (e.g., via a communication link established between the communication device 100 and the peer device). The transceiver circuit 110 may comprise a receiver configured to receive wireless signals and a transmitter configured to transmit wireless signals, and the transceiver circuit 110 may be further configured to perform radio frequency (RF) signal processing. For example, the receiver may convert the received signals into intermediate frequency (IF) or baseband signals to be processed, or the transmitter may receive the IF or baseband signals from the baseband signal processing circuit 120 and convert the received signals into RF wireless signals to be transmitted to the air interface.

The transmitter and the receiver of the transceiver circuit 110 may comprise a plurality of hardware devices to perform RF conversion and RF signal processing. For example, the transmitter and/or the receiver may comprise a power amplifier for amplifying the RF signals, a filter for filtering unwanted portions of the RF signals and/or a mixer for performing radio frequency conversion. According to an embodiment of the invention, the radio frequency may be, for example but not limited to, the frequency of any specific frequency band for a Wi-Fi system, or others.

The baseband signal processing circuit 120 may be configured to process the IF or baseband signals received from or to be transmitted to the transceiver circuit 110. The processor 130 may be configured to handle corresponding communications protocol operations, process signal or data received from or to be transmitted to the baseband signal processing circuit 120, and control overall operations of the communication device 100.

It should be noted that, in order to clarify the concept of the invention, FIG. 1 presents a simplified block diagram of a communication device in which only the components relevant to the invention are shown. As will be readily appreciated by a person of ordinary skill in the art, a communication device may further comprise other components not shown in FIG. 1 and configured for implementing the functions of wireless communication and related signal processing.

According to an embodiment of the invention, the communication device 100 may establish a wireless connection with a peer device and communicate with the peer device. For example, the communication device 100 may transmit signal and data to the peer device and receive signal and data from the peer device. Note that in the embodiments of the invention, the peer device may be another communication device and may be implemented in a similar way as the one shown in FIG. 1.

In a wireless communication environment, such as in a wireless local area network established in compliance with Wi-Fi standards, channel contention is performed prior to actual data transmission to avoid collision. For example, a communication device may wait for a random backoff time before transmission. In addition, the communication device may also perform either physical carrier sensing or virtual carrier sensing before the data transmission to avoid collision. However, in a scenario of dense back and forth data transmission, the channel contention process will be time consuming.

To improve the transmission performance, especially in the scenario of dense back and forth data transmission, methods for interactive data transmission and the communication device (e.g., the communication device 100) utilizing the same, to achieve fast interactive data transmission, are proposed.

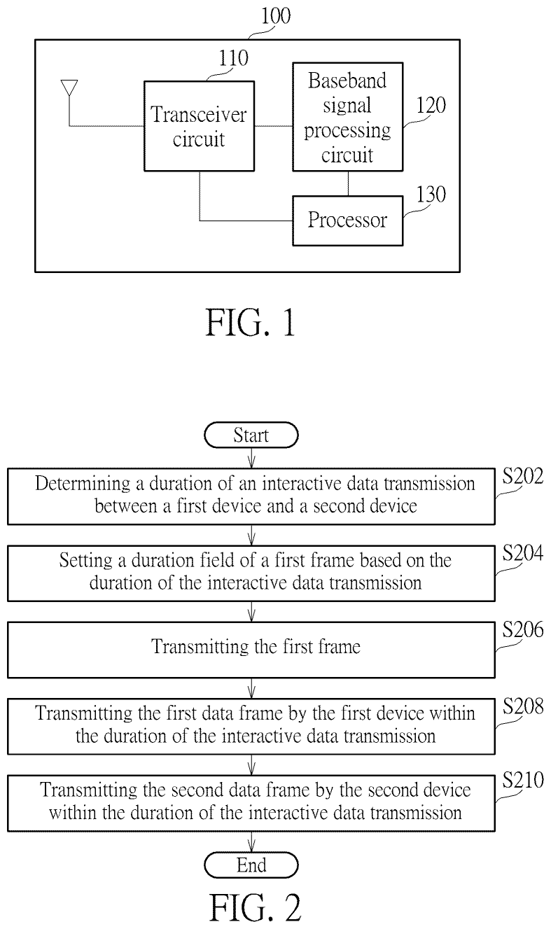

FIG. 2 shows an exemplary flow chart of a method for interactive data transmission according to an embodiment of the invention. The proposed method for interactive data transmission comprises the following steps:

Step S202: determining a duration of an interactive data transmission between a first device and a second device. In the embodiments of the invention, the duration of the interactive data transmission covers a time required for transmitting a first data frame of the first device and a time required for transmitting a second data frame of the second device. Note that in the embodiments of the invention, the time required for transmitting the first data frame, as well as the time required for transmitting the second data frame, comprises the overall necessary channel occupation time to successfully complete the transmission of the first/second data frame and to avoid collision.

Step S204: setting a duration field of a first frame based on the duration of the interactive data transmission.

Step S206: transmitting the first frame. In some embodiments of the invention, the first frame is a Request to Send (RTS) frame transmitted by the first device. In some other embodiments of the invention, the first frame is a Clear to Send (CTS) frame transmitted by the second device.

Step S208: transmitting the first data frame by the first device within the duration of the interactive data transmission.

Step S210: transmitting the second data frame by the second device within the duration of the interactive data transmission.

In the embodiments of the invention, the proposed method may be accomplished by the first device and the second device which are communicating with each other, and both the first device and the second device may be implemented as the communication device 100 shown in FIG. 1. Note that in the embodiments of the invention, the first device may act as an initiator who initiates the data transmission, and the second device may act as a responder who responds to the initiator. In addition, in the embodiments of the invention, Step S208 and/or Step S210 may be repeatedly performed when the duration of the interactive data transmission does not exceed a maximum channel occupation time.

According to an embodiment of the invention, when the first frame is transmitted by the second device (e.g., a responder), the first frame is the CTS frame. In addition, before transmitting the first frame, the second device receives the RTS frame transmitted by the first device (e.g., an initiator). The first frame (i.e., the CTS frame in this embodiment) is transmitted in response to reception of the RTS frame.

In this embodiment, the second device obtains duration information associated with the RTS frame from a duration field of the RTS frame and determines the duration of the interactive data transmission in step S202 according to the duration information associated with the RTS frame and the time required for transmitting the second data frame of the second device.

In addition, the second device may then receive the first data frame transmitted by the first device and accordingly transmit an acknowledgment (ACK) frame in response to reception of the first data frame. In the embodiments of the invention, after transmitting the ACK frame and before transmitting the second data frame, no further RTS frame is transmitted by the second device. That is, no further RTS frame is transmitted by the second device prior to transmission of the second data frame. In addition, in the embodiments of the invention, the second device transmits the second data frame without waiting or counting a backoff time.

According to another embodiment of the invention, when the first frame is transmitted by the first device (e.g., an initiator), the first frame is the RTS frame. The duration information associated with the RTS frame and set in the duration field of the RTS frame is the duration of the interactive data transmission determined by the first device in step S202, and the duration information set in the duration field of the RTS frame covers a time required for transmitting the first data frame of the first device and a time required for transmitting the second data frame of the second device. Note that in the embodiments of the invention, the time required for transmitting the first/second data frame comprises the overall necessary channel occupation time to successfully complete the transmission of the first/second data frame and to avoid collision.

After transmitting the RTS frame and prior to transmission of the first data frame, the first device receives a CTS frame transmitted by the second device, and then transmits the first data frame within the duration of the interactive data transmission. After transmitting the first data frame, the first device receives an ACK frame from the second device within the duration of the interactive data transmission, receives the second data frame transmitted by the second device and transmits an ACK frame to in response to reception of the second data frame within the duration of the interactive data transmission. In the embodiments of the invention, no further RTS frame from the second device is received by the first device prior to reception of the second data frame, and thus no further CTS frame is transmitted by the first device prior to reception of the second data frame.

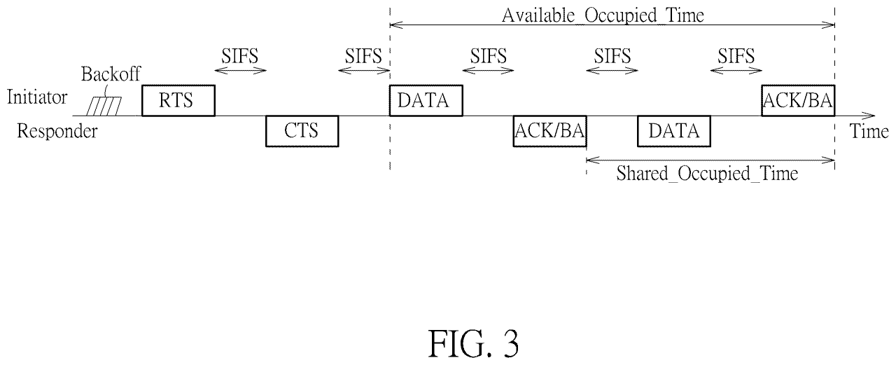

FIG. 3 is a timing diagram showing an interactive data transmission achieved after applying the proposed method according to an embodiment of the invention. The transmissions performed by the initiator are drawn above the time axis and the transmissions performed by the responder are drawn below the time axis. The initiator may be the aforementioned first device and the responder may be the aforementioned second device.

To obtain a right to use a channel as well as to avoid collision, the initiator waits for a backoff time and transmits the RTS frame to the air interface. In some embodiments of the invention, the duration information associated with the RTS frame and set in the duration field of the RTS frame may only cover a time required for transmitting the data frame of the initiator. In some other embodiments of the invention, the duration information associated with the RTS frame and set in the duration field of the RTS frame covers not only a time required for transmitting the data frame of the initiator but also a time required for transmitting the data frame of the responder, such as the duration of the interactive data transmission determined in step S202.

Upon receiving the RTS frame, the responder waits for a Short Interframe Space (SIFS) and transmits the CTS frame to the air interface. In some embodiments of the invention, the duration information associated with the CTS frame and set in the duration field of the CTS frame covers not only the time required for transmitting the data frame of the initiator but also the time required for transmitting the data frame of the responder, such as the duration of the interactive data transmission determined in step S202.

Upon receiving the CTS frame, the initiator waits for a SIFS and transmits a data frame (e.g., the first data frame) to the air interface. In response to reception of the first data frame, the responder waits for a SIFS and transmits an ACK or a Block ACK (BA) frame to the air interface.

In the embodiments of the invention, after transmitting the ACK/BA frame, the responder waits for a SIFS and directly transmits a data frame (e.g., the second data frame) to the air interface, without waiting or counting a backoff time and also without any prior transmission of an RTS frame. In response to reception of the second data frame, the initiator waits for a SIFS and transmits an ACK/BA frame to the air interface.

In the embodiments of the invention, the remaining time (labeled as Shared_Occupied_Time in FIG. 3) after the responder transmitting the ACK/BA frame and before an end of the available time for channel occupation (that is, the available time for the channel to be occupied by the initiator) (labeled as Available_Occupied_Time in FIG. 3) is shared with the responder for further data frame transmission, and the responder may directly transmit data frame without performing channel contention. In the embodiments of the invention, the available time for channel occupation is extended by setting the duration information associated with the RTS or CTS frame or the duration field of the RTS or CTS frame to a value covering not only a time required for transmitting the data frame of the initiator but also a time required for transmitting the data frame of the responder.

According to an embodiment of the invention, the available time for channel occupation (e.g., the Available_Occupied_Time as shown in FIG. 3) may be limited by the maximum channel occupation time, and the maximum channel occupation time may be defined based on a Physical Protocol Data Unit (PPDU) maximum time (e.g., 5.484 ms as defined in 802.11 specification) or a transmission opportunity limit (TXOP) limited (e.g., 6.016 ms for the priority of Video Access Category (AC_VO) as defined in 802.11 specification). In an embodiment of the invention, the time can be shared with the responder (e.g., the Shared_Occupied_Time as shown in FIG. 3) may be derived based on the following equation Eq. (1):

$$[ ( Available\_Occupied \_Time ) - ( transmission time of data frame of the initiator ) - SIFS - ( transmission time of ACK / BA frame of the responder ) ] \qquad Eq . ( 1 )$$

As shown in FIG. 3, no backoff time is required between two data frame transmissions. In addition, no further RTS and CTS frames are transmitted prior to the transmission of the data frame from the responder. Since the responder does not have to perform channel contention (which may at least comprise the operations of counting or waiting for a backoff time, transmitting the RST frame and receiving the CTS frame from the initiator), the time required for interactive data transmission is greatly reduced and fast interactive data transmission is achieved.

As mentioned above, the duration of an interactive data transmission between the initiator and the responder may be determined to cover at least a time required for transmitting a first data frame of the initiator and a time required for transmitting a second data frame of the responder, and a duration field of an RTS frame or a CTS frame may be set based on the determined duration of the interactive data transmission.

With the duration information obtained from the duration field of a received frame, a communication device may configure a Network Allocation Vector (NAV) based on the duration information. The NAV is a virtual carrier-sensing mechanism used with wireless network protocols such as IEEE 802.11 (Wi-Fi). The Medium Access Control (MAC) layer frame headers contain the duration field that specifies the transmission time required for the frame. The devices or stations listening on the wireless medium of the wireless communication environment read the duration field to obtain the duration information and set their NAV, which is an indicator for a device or a station on how long it must defer from accessing the medium, according to the duration information.

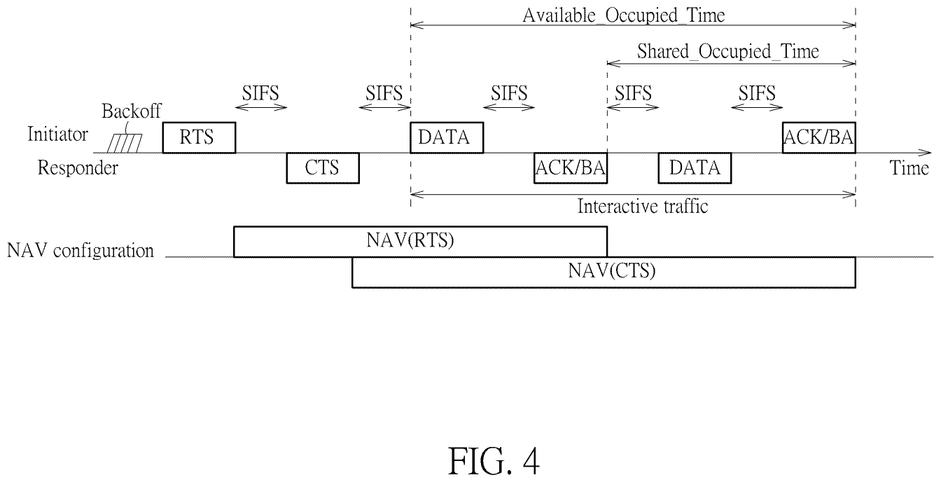

FIG. 4 is a timing diagram showing NAV configurations associated with the RST frame and CTS frame according to a first embodiment of the invention. In the first embodiment of the invention, fast interactive data transmission is achieved by setting the duration field of the CTS frame based on the determined duration of the interactive data transmission, and the setting is performed by a communication device (e.g., the communication device 100) which is the responder relative to a peer device (e.g., another communication device) which is the initiator that initiates the data transmission.

In the embodiments of the invention, the processor (e.g., the processor 130) receives, via the transceiver circuit (e.g., the transceiver circuit 110), the RTS frame from the peer device and obtains duration information associated with the RTS frame from the duration field of the RTS frame. The processor determines a duration of an interactive data transmission according to the duration information associated with the RTS frame and a time required for transmitting at least a data frame from the communication device, and sets a duration field of the CTS frame based on the duration of the interactive data transmission.

In addition, the processor transmits the CTS frame with the duration field set based on the duration of the interactive data transmission in response to the reception of the RTS frame.

After transmitting the CTS frame, the processor further receives, via the transceiver circuit, first data frame from the peer device, transmits, via the transceiver circuit, an ACK/BA frame in response to reception of the first data frame, and transmits, via the transceiver circuit, second data frame within the duration of the interactive data transmission.

In the embodiments of the invention, the duration of the interactive data transmission covers at least a time required for the peer device to transmit the first data frame and a time required for the communication device to transmit the second data frame. In addition, in the embodiments of the invention, the processor transmits the second data frame without counting or waiting for a backoff time for the transmission of the second data frame.

In addition, in the embodiments of the invention, the processor transmits the second data frame without any prior transmission of the RTS frame associated with the second data frame. In addition, in the embodiments of the invention, the processor transmits the second data frame without any prior reception of the CTS frame associated with the second data frame from the peer device.

The NAV configurations represented by two boxes drawn below the time axis in FIG. 4 and labeled NAV(RTS) and NAV(CTS) respectively depict the duration information derived from the duration fields of the RTS frame and CTS frame. The NAV configurations are also indicative of the duration of channel occupancy of the associated frame (that is, for how long a device or a station communicating via the same channel or medium must defer from accessing the channel or medium).

In the first embodiment of the invention, a first end time of channel occupancy derived from the duration information associated with the RTS frame (i.e., the NAV(RTS)) and a second end time of channel occupancy derived from duration information associated with the CTS frame (i.e., the NAV(CTS)) are different. As shown in FIG. 4, the right most boundary of the box labeled NAV(RTS) is the end time of channel occupancy associated with the RTS frame and the right most boundary of the box labeled NAV(CTS) is the end time of channel occupancy associated with the CTS frame, and note that they are not aligned.

In the first embodiment of the invention, the processor may calculate the shared occupied time (e.g., the Shared_Occupied_Time as shown in FIG. 3 or FIG. 4) after receiving the RTS frame from the peer device (i.e., the initiator in the first embodiment of the invention). For example, the shared occupied time (Shared_Occupied_Time) may be derived based on the aforementioned equation Eq. (1).

The processor may calculate the available transmission time of a data frame (that is, the maximum time of transmitting the data frame) of the responder with the shared occupied time based on the following equation Eq. (2):

$$available transmission time of a data frame of the responder = [ ( Shared\_Occupied \_Time ) - 2 * SIFS - ( transmission time of ACK / BA frame of the initiator ) ] \qquad Eq . ( 2 )$$

The processor may further calculate duration information associated with the CTS frame (e.g., the NAV(CTS)) based on the following equation Eq. (3):

$$NAV ( CTS ) = NAV ( RTS ) - ( transmission time of CTS frame of the responder ) - SIFS + ( Shared\_Occupied \_Time ) \qquad Eq . ( 3 )$$

The processor may set the duration field of the CTS frame and transmit the CTS frame to the peer device.

By setting the duration field of the CTS frame according to the duration information calculated based on the equation Eq. (3), the NAV(CTS) is extended and the additional shared occupied time (e.g., the Shared_Occupied_Time as shown in FIG. 3 or FIG. 4) available for data transmission is obtained by the responder.

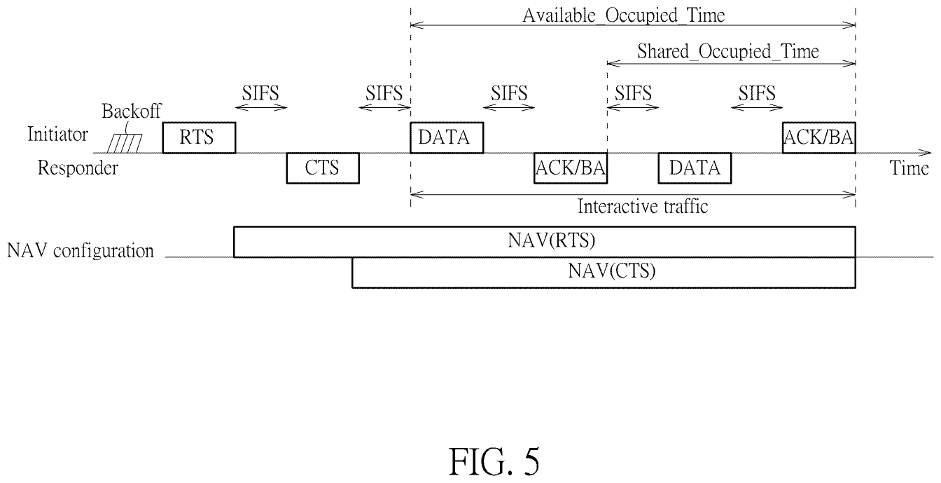

FIG. 5 is a timing diagram showing NAV configurations associated with the RST frame and CTS frame according to a second embodiment of the invention. In the second embodiment of the invention, fast interactive data transmission is achieved by setting the duration field of the RTS frame based on the determined duration of the interactive data transmission, and the setting is performed by a communication device (e.g., the communication device 100) which is the initiator that initiates the data transmission.

In the embodiments of the invention, the processor (e.g., the processor 130) determines a duration of an interactive data transmission between the communication device and a peer device (e.g., another communication device which is the responder), sets a duration field of the RTS frame based on the duration of the interactive data transmission, and transmits, via the transceiver circuit (e.g., the transceiver circuit 110), the RTS frame.

After transmitting the RTS frame, the processor further receives, via the transceiver circuit, the CTS frame from the peer device, transmits, via the transceiver circuit, a first data frame, and then receives, via the transceiver circuit, an ACK/BA from the peer device.

In the embodiments of the invention, the duration of the interactive data transmission covers at least a time required for the communication device to transmit the first data frame and a time required for the peer device to transmit a second data frame.

In the embodiments of the invention, the processor further receives the second data frame within the duration of the interactive data transmission without a backoff time for the transmission of the second data frame counted by the peer device. In addition, the embodiments of the invention, no further RTS frame is received from the peer device prior to reception of the second data frame and no further CTS frame is transmitted by the processor prior to reception of the second data frame.

In the second embodiment of the invention, a first end time of channel occupancy derived from the duration information associated with the RTS frame (i.e., the NAV(RTS)) and a second end time of channel occupancy derived from the duration field or the duration information associated with the CTS frame (i.e., the NAV(CTS)) are the same. As shown in FIG. 5, the right most boundary of the box labeled NAV(RTS) is the end time of channel occupancy associated with the RTS frame and the right most boundary of the box labeled NAV(CTS) is the end time of channel occupancy associated with the CTS frame, and note that they are aligned, since the setting of the duration of the interactive data transmission is performed by the initiator on the RTS frame.

In the second embodiment of the invention, the processor may calculate the available time for channel occupation (e.g., the Available_Occupied_Time as shown in FIG. 3 or FIG. 5) based on the following equation Eq. (4):

$$Available\_Occupied \_Time = ( transmission time of data frame of the initiator ) + SIFS + ( transmission time of ACK / BA frame of the responder ) + SIFS + ( transmission time of data frame of the responder ) + SIFS + ( transmission time of ACK / BA frame of the initiator ) \qquad Eq . ( 4 )$$

The processor may further calculate duration information associated with the RTS frame (e.g., the NAV(RTS)) based on the equation Eq. (4), set the duration field of the RTS frame and transmit the RTS frame to the peer device.

Upon receiving the RTS frame, the responder may calculate the duration associated with the CTS frame (e.g., the NAV(CTS)) based on the duration information associated with the received RTS frame, set the duration field of the CTS frame and transmit the CTS frame to the initiator.

By setting the duration field of the RTS frame according to the duration information calculated based on the equation Eq. (4), the NAV(RTS) is extended and the responder obtains the additional shared occupied time (e.g., the Shared_Occupied_Time as shown in FIG. 3 or FIG. 5) available for data transmission.

In the embodiments of the invention, by setting the duration field of the RTS or CTS frame according to the duration required for interactive data transmission as introduced above, the durations of the RTS and/or CTS frames, as well as the corresponding NAV(RTS) and/or NAV(CTS), can be extended as shown in FIG. 4 and FIG. 5, and the responder can skip channel contention before data frame transmission as the behaviors shown in FIG. 3, FIG. 4 and FIG. 5. Therefore, the time required for interactive data transmission is greatly reduced and fast interactive data transmission is achieved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for interactive data transmission, comprising:
determining a duration of an interactive data transmission between a first device and a second device, wherein the duration of the interactive data transmission covers a time required for transmitting a first data frame of the first device and a time required for transmitting a second data frame of the second device;
setting a duration field of a first frame based on the duration of the interactive data transmission;
transmitting the first frame, wherein the first frame is a Request to Send (RTS) frame transmitted by the first device or a Clear to Send (CTS) frame transmitted by the second device;
transmitting the first data frame by the first device within the duration of the interactive data transmission; and
transmitting the second data frame by the second device within the duration of the interactive data transmission.

2. The method of claim 1, wherein when the first frame is the CTS frame transmitted by the second device, the method further comprises:
receiving the RTS frame transmitted by the first device, wherein the first frame is transmitted in response to reception of the RTS frame;
obtaining duration information associated with the RTS frame, wherein the duration of the interactive data transmission is determined by the second device according to the duration information associated with the RTS frame and the time required for transmitting the second data frame of the second device, and
wherein a first end time of channel occupancy derived from the duration information associated with the RTS frame transmitted by the first device and a second end time of channel occupancy derived from the duration field of the first frame are different.

3. The method of claim 2, further comprising:
receiving the first data frame transmitted by the first device; and
transmitting an acknowledgment frame in response to reception of the first data frame before transmitting the second data frame,
wherein after transmitting the acknowledgment frame, no RTS frame is transmitted by the second device prior to transmission of the second data frame.

4. The method of claim 1, wherein when the first frame is the RTS frame transmitted by the first device, the method further comprises:
receiving the second data frame transmitted by the second device; and
transmitting an acknowledgment frame in response to reception of the second data frame within the duration of the interactive data transmission,
wherein no RTS frame from the second device is received by the first device prior to reception of the second data frame.

5. The method of claim 4, wherein the method further comprises:
receiving the CTS frame transmitted by the second device prior to transmission of the first data frame,
wherein a first end time of channel occupancy derived from the duration field of the first frame and a second end time of channel occupancy derived from a duration field of the CTS frame are the same.

6. A communication device, comprising:
a transceiver circuit, transmitting and receiving a plurality of wireless signals to and from a peer device; and
a processor, receiving, via the transceiver circuit, a Request to Send (RTS) frame from the peer device and obtaining duration information associated with the RTS frame, and in response to reception of the RTS frame, transmitting, via the transceiver circuit, a Clear to Send (CTS) frame,
wherein before transmitting the CTS frame, the processor further determines a duration of an interactive data transmission according to the duration information associated with the RTS frame and sets a duration field of the CTS frame based on the duration of the interactive data transmission, and
wherein the duration of the interactive data transmission covers a time required for the peer device to transmit a first data frame and a time required for the communication device to transmit a second data frame.

7. The communication device of claim 6, wherein after transmitting the CTS frame, the processor further receives, via the transceiver circuit, the first data frame from the peer device, transmits, via the transceiver circuit, an acknowledgment frame in response to reception of the first data frame, and transmits, via the transceiver circuit, the second data frame within the duration of the interactive data transmission.

8. The communication device of claim 7, wherein the processor transmits the second data frame without any prior transmission of the RTS frame.

9. The communication device of claim 7, wherein the processor transmits the second data frame without any prior reception of the CTS frame from the peer device.

10. The communication device of claim 7, wherein the processor transmits the second data frame without waiting for a backoff time.

11. The communication device of claim 6, wherein a first end time of channel occupancy derived from the duration information associated with the RTS frame and a second end time of channel occupancy derived from the duration field of the CTS frame are different.

12. A communication device, comprising:
a transceiver circuit, transmitting and receiving a plurality of wireless signals to and from a peer device; and
a processor, transmitting, via the transceiver circuit, a Request to Send (RTS) frame and receiving, via the transceiver circuit, a Clear to Send (CTS) frame from the peer device,
wherein before transmitting the RTS frame, the processor further determines a duration of an interactive data transmission between the communication device and the peer device and sets a duration field of the RTS frame based on the duration of the interactive data transmission, and
wherein the duration of the interactive data transmission covers a time required for the communication device to transmit a first data frame and a time required for the peer device to transmit a second data frame.

13. The communication device of claim 12, wherein after receiving the CTS frame from the peer device, the processor further transmits, via the transceiver circuit, the first data frame, receives, via the transceiver circuit, an acknowledgment frame from the peer device, and receives, via the transceiver circuit, the second data frame from the peer device within the duration of the interactive data transmission.

14. The communication device of claim 12, wherein no further RTS frame is received from the peer device prior to reception of the second data frame.

15. The communication device of claim 12, wherein no further CTS frame is transmitted by the processor prior to reception of the second data frame.

16. The communication device of claim 12, wherein a first end time of channel occupancy derived from the duration field of the RTS frame and a second end time of channel occupancy derived from a duration field of the CTS frame are the same.
